(19) United States
(12) Patent Application Publication
(10) Pub. No.: US 2026/0203547 A1
(43) Pub. Date: Jul. 16, 2026

(54) TARGETED ROBOTIC PROCESS AUTOMATION BOT DECISIONING

(71) Applicant: INTERNATIONAL BUSINESS MACHINES CORPORATION, Armonk, NY (US)

(72) Inventors: Logan Bailey, Atlanta, GA (US); Jeremy R. Fox, Georgetown, TX (US); Zachary Augustus Silverstein, Georgetown, TX (US); Suman Patra, Raritan, NJ (US)

(21) Appl. No.: 19/019,734

(22) Filed: Jan. 14, 2025

(51) Int. Cl. G06N 3/006; G06N 5/025

(52) U.S. Cl. CPC G06N 3/006; G06N 5/025

(57) ABSTRACT

Targeted robotic process automation (RPA) bot decisioning includes building a user-specific decisioning profile of a user, where the user-specific decisioning profile characterizing user decision-making in performing task actions as part of workflow execution on a user device, monitoring for deployment of workflow tasks and identifying that a deployed workflow task includes a decisioned task action, selecting the user-specific decisioning profile, and executing an RPA bot to perform the decisioned task action based on the user-specific decisioning profile, in which decisioning criteria informed by the user-specific decisioning profile serves as a basis for the execution of the RPA bot in automatically performing the decisioned task action.

### BACKGROUND

Aspects described herein relate to robotic process automation technology, and more specifically to approaches for enhancing activities automatically performed by robotic process automation bots. Robotic process automation (RPA) refers to the automation of task performance using intelligent automation technologies. Automation helps increase the speed and volume of performed tasks as compared to manual performance of the tasks. It is often applied to automate the performance of recurring, repetitive tasks, such as routine tasks performed in the fields of insurance and medical claims processing, data collection and reporting, regulation and compliance checking, and order management, as examples. In a typical architecture, an RPA ‘bot’ runs on a client device to help automate performance of client-side activity. Some RPA bot activity might leverage cloud services provided by one or more servers though application programming interface (API) calling.

### SUMMARY

Shortcomings of the prior art are overcome and additional advantages are provided through the provision of a computer-implemented method. The method builds a user-specific decisioning profile of a user. The user-specific decisioning profile characterizes user decision-making in performing task actions as part of workflow execution on a user device. The method also monitors for deployment of workflow tasks and identifies that a deployed workflow task includes a decisioned task action. The method additionally selects the user-specific decisioning profile. The method further executes an RPA bot to perform the decisioned task action based on the user-specific decisioning profile, in which decisioning criteria informed by the user-specific decisioning profile serves as a basis for the execution of the RPA bot in automatically performing the decisioned task action.

Additional aspects of the present disclosure are directed to systems and computer program products configured to perform the methods described above and herein. The present summary is not intended to illustrate each aspect of, every implementation of, and/or every embodiment of the present disclosure. Additional features and advantages are realized through the concepts described herein.

### BRIEF DESCRIPTION OF THE DRAWINGS

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

FIG. 1 depicts an example computing environment to incorporate and/or use aspects described herein;

FIG. 2 depicts an example process flow for targeted persona infusion for a robotic process automation bot, in accordance with aspects described herein;

FIG. 3 depicts further details of an example targeted robotic process automation decisioning code of FIG. 1 to incorporate and/or use aspects described herein;

FIG. 4 depicts further details of an example user-specific decisioning profile building code to incorporate and/or use aspects described herein; and

FIG. 5 depicts an example process for targeted robotic process automation decisioning, in accordance with aspects described herein.

### DETAILED DESCRIPTION

Described herein are approaches for enhancing robotic process automation (RPA) activities, particularly for providing targeted decision-making (decisioning) by RPA bots. Many executing workflows involve decision-making by an individual as part of workflow execution to progress through one or more workflow tasks. The individual often gains domain knowledge and refines decision-making skills in repetitively performing workflow tasks. However, RPA is largely process-driven and rule-based, with RPA bots following predefined processes. Aligning an individual’s domain-knowledge and decisioning abilities to an RPA bot can be difficult, and sometimes decisions are judgment calls exercised by an individual. Aspects described herein provide solutions for binding characterizations of an individual’s decision-making to an RPA bot, thereby infusing the RPA bot with decisioning abilities that are aligned with those of the individual. This can be useful in a variety of contexts, such as when it is desired to automate task performance with an RPA bot tailored to make decisions in place of a specific individual, including the situation where the individual is no longer available to perform decisioned task actions. In accordance with some aspects, approaches are provided that learn and bind fuzzy logic decisioning to an RPA bot based on an individual’s historical activity and ingesting a holistic user-decisioning profile of that individual.

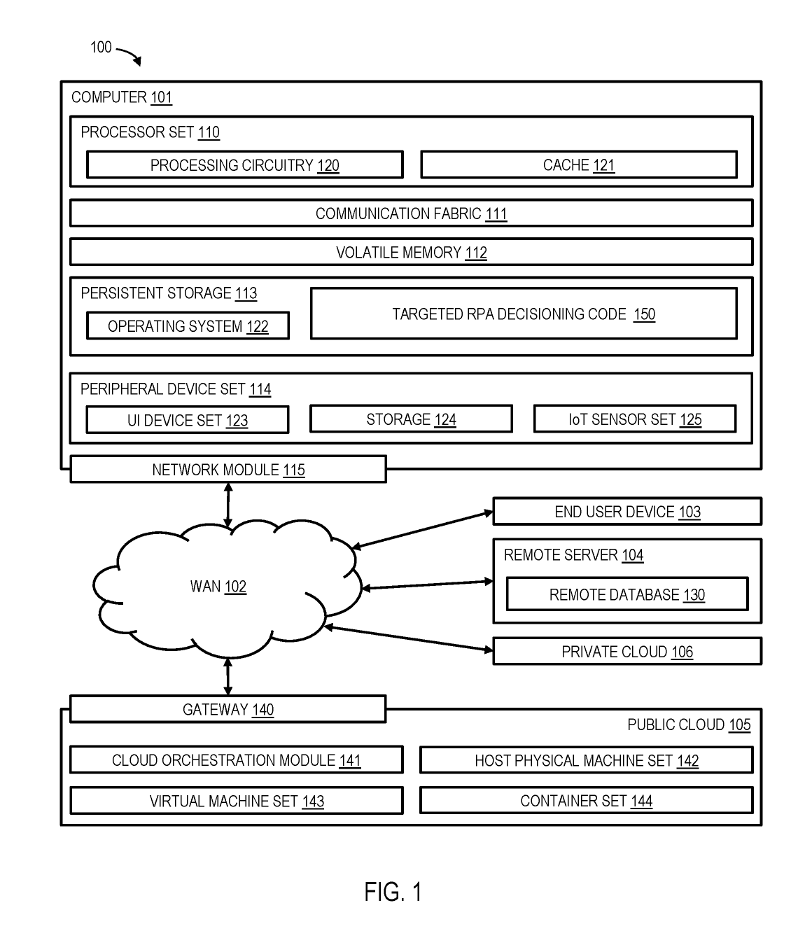

One or more embodiments described herein may be incorporated in, performed by and/or used by a computing environment, such as computing environment 100 of FIG. 1. As examples, a computing environment may be of various architecture(s) and of various type(s), including, but not limited to: personal computing, client-server, distributed, virtual, emulated, partitioned, non-partitioned, cloud-based, quantum, grid, time-sharing, cluster, peer-to-peer, mobile, having one node or multiple nodes, having one processor or multiple processors, and/or any other type of environment and/or configuration, etc. that is capable of executing process(es) that perform any combination of one or more aspects described herein. Therefore, aspects described and claimed herein are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as targeted RPA decisioning code 150 (also referred to herein as block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication Fabric 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

Volatile Memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral Device Set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network Module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote Server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public Cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private Cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud Computing Services and/or Microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above in FIG. 1 is only one example of a computing environment to incorporate, perform, and/or use aspect(s) of the present disclosure. Other examples are possible. For instance, in one or more embodiments, one or more of the components/modules of FIG. 1 are not included in the computing environment and/or are not used for one or more aspects of the present disclosure. Further, in one or more embodiments, additional and/or other components/modules may be used. Other variations are possible.

Computer-implemented methods, computer systems and computer program products relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa. Further, it is noted that advantages described or set-forth explicitly or implicitly herein may not be present in all embodiments described herein, and are not necessarily required of all embodiments described herein.

In some aspects of targeted RPA bot decisioning, a module processes historical decisions and decision criteria gleaned from the interactions of an individual (also referred to herein as a user) to build a consumable user-specific decisioning profile that characterizes the user’s decision-making in that user’s performance of task actions as part of workflow execution on a user device. The workflow includes one or more tasks, and a task action is an action that is taken as part of a task. In examples, the module can leverage decision mining from a process mining tool to recognize and characterize how that particular individual performs task actions, including those for which the individual applies individual decision-making in performing those task actions.

In accordance with another aspect, a process can bind the user-specific decisioning profile to an RPA bot so that the RPA bot, in executing selected task actions, performs the task actions based on that decisioning profile and in line with how the individual would have performed the decisioned task action. In this aspect, decisioning criteria informed by the profile, the decisioning criteria being based on a trained corpus of that individual, serves as a basis for the execution of the RPA bot in automatically performing those decisioned task actions.

Aspects can also mark decision points that differ across individuals based on their differing decisioning profiles resulting from process or task mining usage. For instance, comparisons may be made between different decisioning results obtained from using different user-specific decisioning profiles in executing an RPA bot (‘RPA bot’ can refer to separate instances of an RPA bot running on different client devices) to perform decisioned task actions. An RPA bot can be executed to perform the decisioned task action based on each of a collection of different user-specific decisioning profiles that correspond to different individuals, and a process can compare results obtained from that executing and identify, from the comparing, decision points that differ based on the differing user-specific decisioning profiles. This could be used for any of a variety of downstream purposes. As one example, it could be used to develop selections for key decision points in a workflow, the decision points corresponding to decisioned task actions. The selections in this context could be different options, perhaps each appropriate or viable given the circumstances, that differing individuals with similar or different experience might decide to take. In this manner, decision options can be developed and deployed, and those options could change over time with the update, addition, or removal of options, if desired.

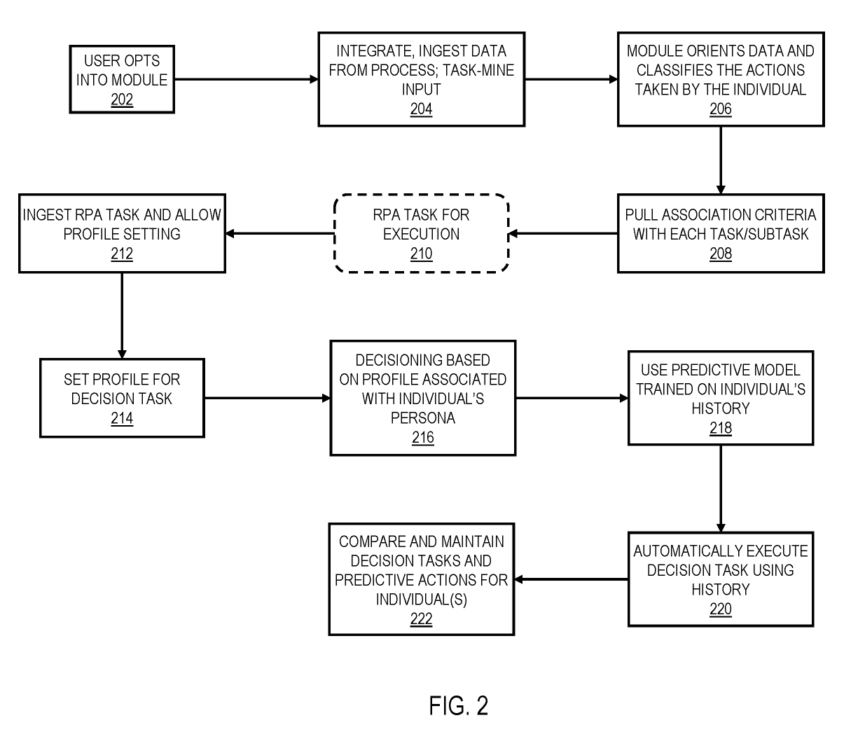

To assist in the description of various aspects provided, FIG. 2 depicts an example process flow for targeted persona infusion for a robotic process automation bot. One or more aspects of the process flow could be performed in whole or in part on one or more computer systems, for instance one or more computer systems that host or provide, or are in communication with system(s) that host or provide, a robotic process automation tool and/or components thereof.

The process flow of FIG. 2 includes the user opting-in (202) to a module to perform aspects of the process flow. User opt-in could, for instance, result in the installation, dispatch, and/or initiation of software on a computer device of the user to perform subsequent aspects of the process flow.

Another aspect of the process flow of FIG. 2 is the building of a user-specific decisioning profile of the user. The user-specific decisioning profile ultimately provides a characterization of user decision-making in performing task actions as part of workflow execution on the user device. In this regard, the user performs interactions on or using the user device, such as a computer system. The user’s actions help progress through a workflow that executes on the user device. The workflow includes tasks, and the interactions include the user interacting on/using the user device to perform the task actions as part of the execution of the workflow. The process flow therefore can include a module monitoring these user interactions on the platform, integrating and ingesting (204) data that indicates those interactions of the user in progressing through the workflow, and data-mining that data, for instance data-mining of the ingested data to identify at least some of the interactions and the task actions. In specific examples, a task mining agent is dispatched to perform this mining. Example integration that is performed is integration with a user or system’s data feeds or logs for the user. Logs (process logs, event logs, etc.) can be informative of user interactions and the circumstances surrounding them. In some examples, the mining includes embedded action processing by way of process mining, for instance process mining based on an automated analysis of graphical user interface snapshots (that are part of the ingested data) to identify at least some of the interactions and the task actions. In some examples, screenshots of the GUI through which the user interacts to perform task actions are obtained, and those screenshots can be automatically analyzed to identify what interactions are performed and the context surrounding them. As yet another example, a process analyzes transaction system events to understand the workflow, tasks, task actions, and/or user interactions involved.

Continuing with FIG. 2, the process flow also includes the module orienting (206) the data and classifying the actions taken by the individual within specific platform tasks and/or the workflow generally. Classifying the task actions identifies various types of task actions, including user-decisioned task actions performed by the user applying the user decision-making.

One example type of task action is a ‘straight-forward’ task action characterized in that it is a static task action, for instance it does not vary as between workflow executions or across different users progressing through the workflow. An example static task action is an action that is part of each execution of the workflow to allocate a processor at a given time to begin executing a workload.

Another example type of task action is a ‘derived’ task action characterized in that it is derived from dynamic values or other related values of the system. For instance, the action might be to perform a given action if a given parameter exceeds a threshold. An example would be taking an action to offload a portion of a workload of a system if a monitored processor utilization value of the system reaches 95%. This may be based on a rule that states that workload should be offloaded if the processor utilization value exceeds that threshold.

A third type of task action is a decisioned task action, which is a task action that is determined to be based on a user’s decisioning. As an example, a user observing resource utilization on a system might decide to provision an additional processor to the system under any of varying circumstances that the user decides warrant the action. The decision might be based on a user’s interpretation of parameters, content fields, or more generally the context or circumstances that surrounded the decision. The user might have observed that processor utilization exceeded 93% and the user might expect an imminent addition of workload to the system, for example. The steps may be flagged manually by users, or automatically based on observing the action over some number of iterations by identifying any associated fields and the aggregate association with the specific action. In some examples, if the classification (performed at 206) of a task action into a task type does not meet some threshold confidence level, for instance 95% or higher as an example, then the task action may be classified a decisioned task action.

Continuing with FIG. 2, the process flow includes the module tracking the user-decisioned task actions (which could be tasks or actions/subtasks that are part of those tasks) and determining the decisioning criteria, as association criteria (208), that may be associated with those actions. The determined association criteria associated with user-decisioned task actions can be determined as criteria upon which performance of the user-decisioned task actions by the user is at least partially based. In this regard, the user’s performance of a task action may be based on one or many factors, and thus a goal may be to identify the criteria on which the user’s decisioning is based, and incorporate that as decisioning criteria into the user-specific decisioning profile. Some association criteria identified at 208 could be unstructured and based on manual identification or on sentiment or interpretation of an unstructured text field. It could, for instance, be flagged by a user or identified by the module reading sentiment of a given unstructured text field or interpreting the data. Unstructured criteria could be criteria for which there have been no identified rules that can be followed. Some association criteria identified at 208 could be structured criteria informed by data fields being associated with, or predictors of, user performance of a user-decisioned task action. For instance, it may be determined that a user looks to a variety of fields and makes a decision based on the association or predictive factors of those fields, applying rule-based decision-making. Yet other association criteria identified at 208 may be ‘unknown’, meaning that the nature of their association to the user-decisioned task action has not yet been identified. This type of criteria could be determined initially based on inference by a neural network based on training the neural network over time. In some examples, criteria may initially be identified as unknown association criteria. Over time, and as the system gathers more data, for instance data surrounding multiple instances of workflow execution, the system might be able to better identify the criteria’s role in influencing user decision-making. What was initially unknown association criteria might be later identified as unstructured association criteria after learning how the criteria might influence the decision-making but not yet having constructed accurate rule(s) around the criteria’s effect on the decision-making. Eventually, the criteria might be identified as structured association criteria after learning enough that well-defined rule(s) can be built around the criteria’s effect on the user decision-making and understanding the specific decisioning that the user is expected to make given an input set of criteria.

The association criteria can represent a characterization of the user’s decision-making in performing user-decisioned task actions as part of the workflow execution. In a specific example, the characterization can be in the form of weights, values, parameters, or the like that can be applied to various other data, for instance data that is part of the workflow execution, to produce outputs that represent decision(s) that the user may be expected to take in performing a task action. There may be confidence levels associated with various alternative decisions for performing that task action. Ultimately, it may be desired to provide a user-specific decisioning profile that confidently predicts user decisions (e.g., with some threshold confidence) in performing workflow task actions.

Continuing with the process flow of FIG. 2, a process monitors for deployment of workflow tasks (210). Some such tasks may be or include decisioned task actions deployed to an RPA tool or RPA bot thereof for handling. In a specific example, a module residing on (executing on or in conjunction with) an RPA tool or other software watches a deployed workflow task. The deployed workflow task may be totally extracted/identified from an individual’s interactions, or the task may be built first and then monitored from the perspective of the user train the extraction/identification of the task. In any case, a deployed workflow task can be ingested and processed to identify that the deployed workflow task includes a decisioned task action. The process flow can allow profile setting (212), for instance allow selection (manually by a user or automatically, as examples) of a given ‘persona’ for an RPA bot to execute the perform the decisioned task action. In other words, a profile can be set (214) for the decisioned task action so that the RPA software inherits the persona of a user from which the selected user-specific decisioning profile was built. The process selects the user-specific decisioning profile and executes an RPA bot to perform the decisioned task action based on the user-specific decisioning profile, in which decisioning criteria informed by the user-specific decisioning profile serves as a basis for the execution of the RPA bot in automatically performing the decisioned task action. The decisioning with respect that decisioned task action will be based on the profile of that individual’s persona (216), the process uses (218) a predictive model (in this example) that is trained on the individual’s history – e.g., using the weights, parameters, etc. of the user-specific decisioning profile), and automatically executes (220) the decision task using that history. For instance, the RPA bot is executed with a neural network or other decisioning model that is trained on and/or uses weighting informed by the user-specific decisioning profile to the exclusion of other user-specific decisioning profiles of other individuals.

In a specific embodiment, executing the RPA bot to perform the decisioned task action based on the user-specific decisioning profile includes training a predictive model using the user-specific decisioning profile to inform weights of the predictive model, and the RPA bot applies the trained predictive model to perform the decisioned task action. This allows a given base or template model to be deployed that a process can, after profile selection based on a desired persona for the RPA bot, train on the selected individual profile so that the RPA bot performs as would the individual to which the user-specific decisioning profile corresponds.

In some embodiments, the module may additionally (FIG. 2, 222) compare and maintain results of decision tasks and predictive actions pertaining to different users. Comparing decisioning results of different users in this context refers to a comparison of how RPA bot(s) execute to perform decisioned task actions based on different user-specific profiles, in other words comparing the different decisions that might be taken for a decisioned task action under different user profiles. Thus, a user-specific decisioning profile built and used in the flow of FIG. 2, may be just one decisioning profile of a collection of tens, hundreds, or thousands of other user-specific decisioning profiles that are for a corresponding number of other individuals and that individually serve as a basis on which an RPA bot is executed to perform the decisioned task action. A process comparing results obtained from executing the RPA bot can identify, from the comparing, decision points that differ based on differing user-specific decisioning profiles. This can be useful to compare and contrast how different users (who may have same, similar, or different levels of expertise, experience, training, etc.) differ in their decision-making. It can also inform task actions that might have different but legitimate options in terms of how, when, or if they are performed, creating the ability to inject selection element or other options into the workflow for automatic or manual selection. Various other uses of the comparison are possible.

As described herein, aspects tailor RPA execution to perform decisioning tasks and interactions based on how a user interprets associated criteria, as learned from ingesting and mining data. Aspects process RPA tasks and determine singular steps, execution pieces, or code chunks that are decisioned task actions. Aspects additionally process historical decisions and decision criteria from an individual, leveraging decision mining from a process mining tool to identify actionable persona actions for a specific individual, to build a consumable decisioning profile based on the trained corpus of that individual. An RPA bot may be bound to that decisioning profile, and decisions may be taken by way of the executing RPA bot. Aspects may be particularly useful for automating workflows or portions thereof – such as individual tasks or actions of those tasks – and specifically task actions.

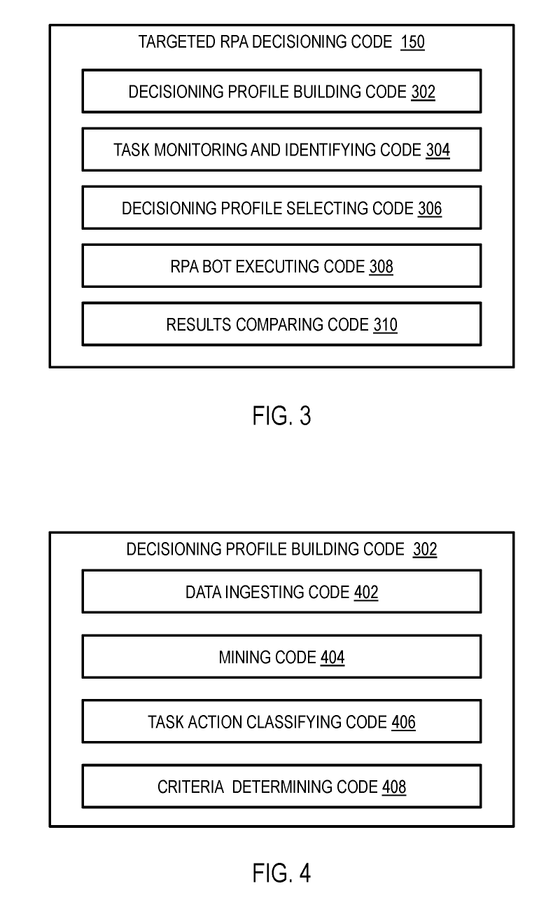

FIG. 3 depicts further details of example targeted robotic process automation decisioning code (e.g., targeted robotic process automation decisioning code 150 of FIG. 1) to incorporate and/or use aspects described herein. In one or more aspects, targeted robotic process automation decisioning code 150 includes, in one example, various sub-modules to be used to perform targeted robotic process automation decisioning. The sub-modules are, e.g., computer readable program code (e.g., instructions) in computer readable media, e.g., storage (persistent storage 113, cache 121, storage 124, other storage, as examples). The computer readable storage media may be part of one or more computer program products and the computer readable program code may be executed by and/or using one or more computing devices (e.g., one or more computers, such as computer(s) 101, computers of cloud 105/106, and/or other computers; one or more servers, such as remote server(s) 104 and/or other remote servers; one or more devices, such as end user device(s) 103 and/or other end user devices; one or more processors or nodes, such as processor(s) or node(s) of processor set 110 and/or other processor(s) or node(s); processing circuitry, such as processing circuitry 120 of processor set 110 and/or other processing circuitry; and/or other computing devices, etc.). Additional and/or other computers, servers, devices, processors, nodes, processing circuitry and/or computing devices may be used to execute one or more of the sub-modules and/or portions thereof. Many examples are possible.

Referring to FIG. 3, targeted robotic process automation (RPA) decisioning code 150 includes (i) decisioning profile building code 302 (a specific example of which is depicted and described with reference to FIG. 4) for building a user-specific decisioning profile of a user, (ii) task monitoring and identifying code 304 for monitoring for deployment of workflow tasks and identifying that a deployed workflow task includes a decisioned task action, (iii) decisioning profile selecting code 306 for selecting the user-specific decisioning profile, (iv) RPA bot executing code 308 for executing an RPA bot to perform the decisioned task action based on the user-specific decisioning profile, and (v) results comparing code 310 for comparing results obtained from executing the RPA bot and identifying, from the comparing, decision points that differ based on differing user-specific decisioning profiles.

FIG. 4 depicts further details of an example user-specific decisioning profile building code to incorporate and/or use aspects described herein, for instance user-specific decisioning profile building code 302 of FIG. 3. Code 302 includes (i) data ingesting code 402 for ingesting data indicating interactions of the user in progressing through a workflow executing on the user device, (ii) mining code 404 for performing mining of the ingested data, for instance data-mining and/or process mining, (iii) task action classifying code 406 for classifying task actions and identifying user-decisioned task actions performed by the user applying user decision-making, and (iv) criteria determining code 408 for determining association criteria that is associated with the user-decisioned task actions.

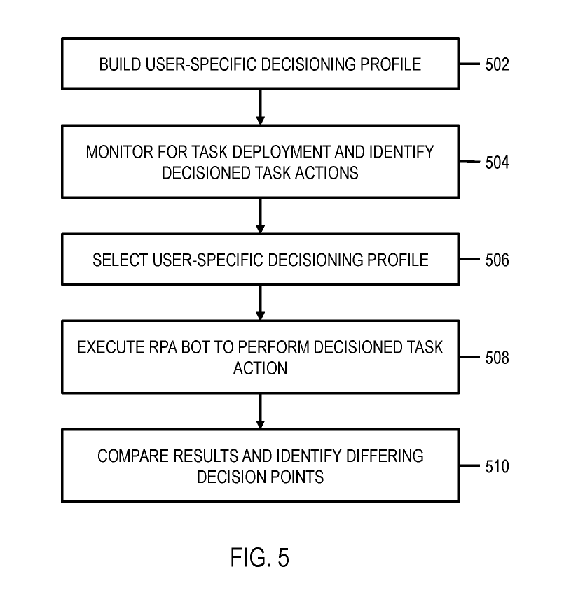

FIG. 5 depicts an example process for targeted robotic process automation decisioning, in accordance with aspects described herein. The process may be executed, in one or more examples, by a processor or processing circuitry of one or more computers/computer systems, such as those described herein, and more specifically those described with reference to FIG. 1. In one example, code or instructions implementing the process(es) of FIG. 5 are part of a module, such as code module 150. In other examples, the code may be included in one or more code modules and/or in one or more code sub-modules of the one or more modules. Various options are available.

The process of FIG. 5 builds (502) a user-specific decisioning profile of a user. The user-specific decisioning profile characterizes user decision-making in performing task actions as part of workflow execution on a user device. The process also monitors (504) for deployment of workflow tasks and identifying that a deployed workflow task includes a decisioned task action. The process also selects (506) the user-specific decisioning profile, and then executes (508) an RPA bot to perform the decisioned task action based on the user-specific decisioning profile, in which decisioning criteria informed by the user-specific decisioning profile serves as a basis for the execution of the RPA bot in automatically performing the decisioned task action.

In some embodiments, executing (508) the RPA bot to perform the decisioned task action based on the user-specific decisioning profile includes training a predictive model using the user-specific decisioning profile to inform weights of the predictive model, and the RPA bot applies the trained predictive model to perform the decisioned task action.

In some embodiments, the user-specific decisioning profile is one decisioning profile of a collection of user-specific decisioning profiles based on which the RPA bot is executed to perform the decisioned task action. In these embodiments, the process can compare (510) results obtained from executing the RPA bot and identifying, from the comparing, decision points that differ based on differing user-specific decisioning profiles.

In a specific example of building the user-specific decisioning profile, the process ingests data indicating interactions of the user in progressing through a workflow executing on the user device. The workflow includes tasks, and the interactions include the user interacting on the user device to perform the task actions as part of execution of the workflow. The process then performs mining of the ingested data, for instance data-mining of the ingested data to identify at least some of the interactions and the task actions and/or process mining based on automated analysis of graphical user interface snapshots of the ingested data to identify at least some of the interactions and the task actions. The process classifies the task actions, where this classifying identifies user-decisioned task actions performed by the user applying the user decision-making, and determines association criteria that are associated with the user-decisioned task actions and serve as criteria upon which performance of the user-decisioned task actions by the user is at least partially based. Determining the association criteria can identify (i) structured criteria informed by data fields being associated with, or predictors of, user performance of a user-decisioned task action of the user-decisioned task actions, (ii) unknown criteria initially based on inference by a neural network, and/or (iii) unstructured criteria based on manual identification or on sentiment or interpretation of an unstructured text field.

Although various embodiments are described above, these are only examples.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A method including:
building a user-specific decisioning profile of a user, the user-specific decisioning profile characterizing user decision-making in performing task actions as part of workflow execution on a user device;
monitoring for deployment of workflow tasks and identifying that a deployed workflow task includes a decisioned task action;
selecting the user-specific decisioning profile; and
executing an RPA bot to perform the decisioned task action based on the user-specific decisioning profile, in which decisioning criteria informed by the user-specific decisioning profile serves as a basis for the execution of the RPA bot in automatically performing the decisioned task action.

2. The method of claim 1, wherein the building includes:
ingesting data indicating interactions of the user in progressing through a workflow executing on the user device, the workflow including tasks, and the interactions including the user interacting on the user device to perform the task actions as part of execution of the workflow;
classifying the task actions, the classifying identifying user-decisioned task actions performed by the user applying the user decision-making;
determining association criteria that is associated with the user-decisioned task actions and serve as criteria upon which performance of the user-decisioned task actions by the user is at least partially based.

3. The method of claim 2, further including performing data-mining of the ingested data to identify at least some of the interactions and the task actions.

4. The method of claim 2, further including performing process mining based on automated analysis of graphical user interface snapshots of the ingested data to identify at least some of the interactions and the task actions.

5. The method of claim 2, wherein determining the association criteria identifies structured criteria informed by data fields being associated with, or predictors of, user performance of a user-decisioned task action of the user-decisioned task actions.

6. The method of claim 2, wherein determining the association criteria identifies unknown criteria initially based on inference by a neural network.

7. The method of claim 2, wherein determining the association criteria identifies unstructured criteria based on manual identification or on sentiment or interpretation of an unstructured text field.

8. The method of claim 1, wherein the user-specific decisioning profile is one decisioning profile of a collection of user-specific decisioning profiles based on which the RPA bot is executed to perform the decisioned task action, and wherein the method further includes comparing results obtained from executing the RPA bot and identifying, from the comparing, decision points that differ based on differing user-specific decisioning profiles.

9. The method of claim 1, wherein the executing the RPA bot to perform the decisioned task action based on the user-specific decisioning profile includes training a predictive model using the user-specific decisioning profile to inform weights of the predictive model, wherein the RPA bot applies the trained predictive model to perform the decisioned task action.

10. A computer system comprising:
at least one computing device;
a set of one or more computer readable storage media; and
program instructions, collectively stored in the set of one or more computer readable storage media, for causing the at least one computing device to perform computer operations including:
building a user-specific decisioning profile of a user, the user-specific decisioning profile characterizing user decision-making in performing task actions as part of workflow execution on a user device;
monitoring for deployment of workflow tasks and identifying that a deployed workflow task includes a decisioned task action;
selecting the user-specific decisioning profile; and
executing an RPA bot to perform the decisioned task action based on the user-specific decisioning profile, in which decisioning criteria informed by the user-specific decisioning profile serves as a basis for the execution of the RPA bot in automatically performing the decisioned task action.

11. The computer system of claim 10, wherein the building includes:
ingesting data indicating interactions of the user in progressing through a workflow executing on the user device, the workflow including tasks, and the interactions including the user interacting on the user the device to perform task actions as part of execution of the workflow;
classifying the task actions, the classifying identifying user-decisioned task actions performed by the user applying the user decision-making;
determining association criteria that is associated with the user-decisioned task actions and serve as criteria upon which performance of the user-decisioned task actions by the user is at least partially based.

12. The computer system of claim 11, wherein the computer operations further include performing at least one selected from the group consisting of: data-mining of the ingested data to identify at least some of the interactions and the task actions; and process mining based on automated analysis of graphical user interface snapshots of the ingested data to identify at least some of the interactions and the task actions.

13. The computer system of claim 11, wherein determining the association criteria identifies at least one selected from the group consisting of: structured criteria informed by data fields being associated with, or predictors of, user performance of a user-decisioned task action of the user-decisioned task actions; unknown criteria initially based on inference by a neural network; and unstructured criteria based on manual identification or on sentiment or interpretation of an unstructured text field.

14. The computer system of claim 10, wherein the user-specific decisioning profile is one decisioning profile of a collection of user-specific decisioning profiles based on which the RPA bot is executed to perform the decisioned task action, and wherein the computer operations further include comparing results obtained from executing the RPA bot and identifying, from the comparing, decision points that differ based on differing user-specific decisioning profiles.

15. The computer system of claim 10, wherein the executing the RPA bot to perform the decisioned task action based on the user-specific decisioning profile includes training a predictive model using the user-specific decisioning profile to inform weights of the predictive model, wherein the RPA bot applies the trained predictive model to perform the decisioned task action.

16. A computer program product including:
a set of one or more computer-readable storage media; and
program instructions, collectively stored in the set of one or more computer-readable storage media, for causing at least one computing device to perform computer operations including:
building a user-specific decisioning profile of a user, the user-specific decisioning profile characterizing user decision-making in performing task actions as part of workflow execution on a user device;
monitoring for deployment of workflow tasks and identifying that a deployed workflow task includes a decisioned task action;
selecting the user-specific decisioning profile; and
executing an RPA bot to perform the decisioned task action based on the user-specific decisioning profile, in which decisioning criteria informed by the user-specific decisioning profile serves as a basis for the execution of the RPA bot in automatically performing the decisioned task action.

17. The computer program product of claim 16, wherein the building includes:
ingesting data indicating interactions of the user in progressing through a workflow executing on the user device, the workflow including tasks, and the interactions including the user interacting on the user device to perform the task actions as part of execution of the workflow;
classifying the task actions, the classifying identifying user-decisioned task actions performed by the user applying the user decision-making;
determining association criteria that is associated with the user-decisioned task actions and serve as criteria upon which performance of the user-decisioned task actions by the user is at least partially based.

18. The computer program product of claim 17, wherein the computer operations further include performing at least one selected from the group consisting of: data-mining of the ingested data to identify at least some of the interactions and the task actions; and process mining based on automated analysis of graphical user interface snapshots of the ingested data to identify at least some of the interactions and the task actions.

19. The computer program product of claim 17, wherein determining the association criteria identifies at least one selected from the group consisting of: structured criteria informed by data fields being associated with, or predictors of, user performance of a user-decisioned task action of the user-decisioned task actions; unknown criteria initially based on inference by a neural network; and unstructured criteria based on manual identification or on sentiment or interpretation of an unstructured text field.

20. The computer program product of claim 16, wherein the executing the RPA bot to perform the decisioned task action based on the user-specific decisioning profile includes training a predictive model using the user-specific decisioning profile to inform weights of the predictive model, wherein the RPA bot applies the trained predictive model to perform the decisioned task action.
